(19) United States
(12) Patent Application Publication
(10) Pub. No.: US 2026/0264875 A1
(43) Pub. Date: Sep. 10, 2026

(54) MARINE TANK TRANSFER REFUELING SYSTEM

(71) Applicant: Shanghai Chengfei Aviation Special Equipment Co.,Ltd., Shanghai (CN)

(72) Inventors: Pei CHEN, Shanghai (CN); Gang LIN, Shanghai (CN); Zhiyun YANG, Shanghai (CN); Yigen CHU, Shanghai (CN); Tong YAO, Shanghai (CN); Xiaodong CUI, Shanghai (CN); Xuan ZHENG, Shanghai (CN)

(73) Assignee: Shanghai Chengfei Aviation Special Equipment Co.,Ltd., Shanghai (CN)

(21) Appl. No.: 19/307,113

(22) Filed: Aug. 22, 2025

(30) Foreign Application Priority Data
Mar. 5, 2025 (CN) 202510256312.7

(51) Int. Cl. B64F 1/28

(52) U.S. Cl. CPC B64F 1/28

(57) ABSTRACT

Provided is a marine tank transfer refueling system. The marine tank transfer refueling system includes a first hose, an aviation fuel pump, a filter separator, a flowmeter, an automatic regulating valve and a second hose. The filter separator has a first communication port, a second communication port, a third communication port, a fourth communication port and a fifth communication port. The first communication port communicates with the aviation fuel pump. The second communication port communicates with the flowmeter. The fourth communication port communicates with a first fuel port of the return fuel tank through an air discharge valve. The fifth communication port communicates with a first pipeline between the aviation fuel pump and the first hose, a second fuel port of the return fuel tank communicates with the first pipeline. The return fuel tank further has a fuel unloading port for releasing residual fuel.

### CROSS-REFERENCE TO RELATED APPLICATION(S)

This application relates and claims priority to Chinese Patent Application No. 202510256312.7 filed Mar. 5, 2025, the disclosure of which is incorporated herein by reference in its entirety.

### TECHNICAL FIELD

The present disclosure relates to the technical field of marine refueling, and in particular, to a marine tank transfer refueling system.

### BACKGROUND

In the related art, a marine structure such as a marine platform or a ship is equipped with a marine platform helicopter refueling system. The refueling system may refuel a flight equipment such as a helicopter and may also pump out aviation fuel from the helicopter to facilitate the overhauling of the flight equipment. However, the structure of existing refueling systems is relatively complex, the fuel supply means is greatly limited, the compatibility is poor, and the safety is relatively low.

### SUMMARY

The present disclosure provides a marine tank transfer refueling system. The marine tank transfer refueling system has a relatively simple structure, fewer restrictions on supply manners, and better compatibility. It can not only enable refueling or defueling of the aircraft, but also enable the filling or tank transfer of an aviation kerosene tank container on a marine platform, and has relatively high working safety.

The present disclosure discloses a marine tank transfer refueling system. The marine tank transfer refueling system includes a first hose, an aviation fuel pump, a filter separator, a flowmeter, an automatic regulating valve and a second hose which are connected in sequence. The first hose is configured to be connected to a fuel supply tank. The second hose is configured to be connected to a fuel receiving tank. The marine tank transfer refueling system further includes a return fuel tank, the filter separator has a first communication port, a second communication port, a third communication port, a fourth communication port and a fifth communication port. The first communication port communicates with the aviation fuel pump. The second communication port communicates with the flowmeter. The third communication port is configured to be connected to a fuel unloading pipe and release residual fuel to an external device. The fourth communication port communicates with a first fuel port of the return fuel tank through an air discharge valve. The fifth communication port communicates with a first pipeline between the aviation fuel pump and the first hose. A second fuel port of the return fuel tank communicates with the first pipeline, and a position where the second fuel port and the first pipeline are connected is located upstream of a position where the fifth communication port and the first pipeline are connected. The return fuel tank further has a fuel unloading port for releasing residual fuel.

In the actual working process, the first hose and the second hose are respectively connected to the fuel supply tank and the fuel receiving tank, and the working state of the aviation fuel pump is controlled according to actual needs, so that the aviation fuel within the fuel supply tank is injected into the fuel receiving tank (such as, the fuel tank of the helicopter or the aviation kerosene tank container on the marine platform), or the aviation fuel in the fuel receiving tank is pumped into the fuel supply tank. Since the flowmeter and the automatic regulating valve are disposed on the fuel circuit, the opening/closing of the automatic regulating valve and the synchronous start/stop of the aviation fuel pump are determined according to the feedback of the signal of the flowmeter, to achieve the controllable transferring or refueling of the aviation fuel. By means of this feedback adjustment, the structural limitation of refueling or transferring is reduced. As a result, it can be compatible with various models of fuel tanks for refueling or transferring, thereby being conducive to improving the compatibility of the marine tank transfer refueling system. The additional fuel return tank is used to balance the pressure in the fuel circuit, so that a zero-pressure storage condition inside the entire fuel circuit is ensured, thereby improving the working safety of the marine tank transfer refueling system. In addition, the fuel return tank and the filter separator are respectively provided with the fuel unloading pipe and the fuel unloading port, so that the residual fuel can be released to the outside of the device, and the phenomenon of excessive pressure inside the fuel circuit is further avoided, thereby further improving the working safety of the marine tank transfer refueling system.

### BRIEF DESCRIPTION OF DRAWINGS

FIG. 1 is a schematic diagram of an internal fuel circuit of a marine tank transfer refueling system according to an embodiment of the present disclosure.

FIG. 2 is a schematic structural diagram of a marine tank transfer refueling system according to an embodiment of the present disclosure.

FIG. 3 is a schematic structural diagram of a marine tank transfer refueling system with a support frame removed according to an embodiment of the present disclosure.

FIG. 4 is a schematic structural diagram of the structure shown in FIG. 3 in another direction.

### LIST OF REFERENCE NUMBERS

1 first hose
2 aviation fuel pump
3 filter separator
301 first communication port
302 second communication port
303 third communication port
304 fourth communication port
305 fifth communication port
4 flowmeter
5 automatic regulating valve
6 second hose
7 fuel return tank
701 first fuel port
702 second fuel port
703 fuel unloading port
8 fuel unloading pipe
9 first pipeline
10 closed-circuit sampler
11 sampling main pipe
12 first sampling pipeline
13 first sampling control valve
14 second sampling pipeline
15 second sampling control valve
16 third sampling pipeline
17 third sampling control valve
18 second pipeline
19 third pipeline
20 test branch pipe
21 first differential pressure gauge
22 first connection branch pipe
23 first on-off valve
24 fourth pipeline
25 second on-off valve
26 safety valve
27 electromagnetic control valve
28 first one-way valve
29 third switch valve
30 second connection branch pipe
31 second differential pressure gauge
32 fifth pipeline
33 third differential pressure gauge
34 manual pressure relief valve
35 second one-way valve
36 three-way control valve
361 first valve port
362 second valve port
363 third valve port
37 third one-way valve
38 coarse filter ball valve assembly
39 self-priming tank
40 fuel unloading valve group
41 manual fuel unloading valve
42 air discharge valve
43 fourth on-off valve
44 parallel branch
45 fifth on-off valve
46 fourth one-way valve
47 safety control valve
48 support seat
481 support frame
482 support bottom plate
4821 forklift handling hole
49 mounting lifting lug
50 first hose reel
51 second hose reel

### DETAILED DESCRIPTION

The present disclosure will be further described in detail in conjunction with the drawings and embodiments below. It is to be understood that the specific embodiments described herein are merely used for explaining the present disclosure and are not intended to limit the present disclosure. It is also be noted that, for ease of description, only some, but not all, of the structures related to the present disclosure are shown in the drawings.

In the description of the present disclosure, unless otherwise expressly specified and limited, the term “connected to each other”, “connected”, or “fixed” is to be construed in a broad sense, for example, as securely connected, or detachably connected, or integrated; mechanically connected or electrically connected; directly connected to each other, indirectly connected to each other via an intermediary, internal connection between two elements, or interaction between two elements. For those of ordinary skill in the art, specific meanings of the preceding terms in the present disclosure may be understood based on specific situations.

In the description of this embodiment, orientations or positional relationships indicated by terms “above”, “below”, “left”, “right”, “front”, “rear” and the like are based on orientations or positional relationships shown in the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. Moreover, terms “first” and “second” are used only to distinguish between descriptions and have no special meaning.

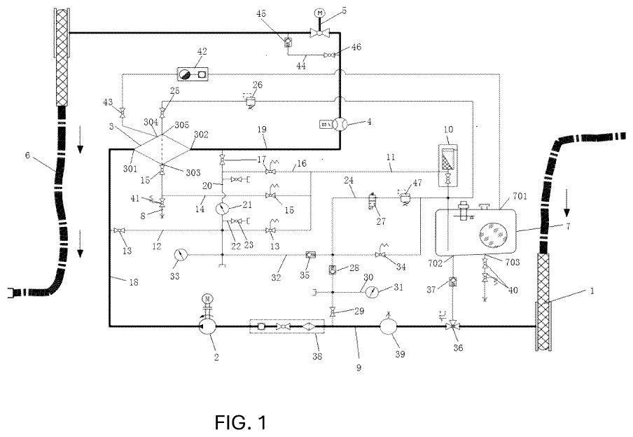

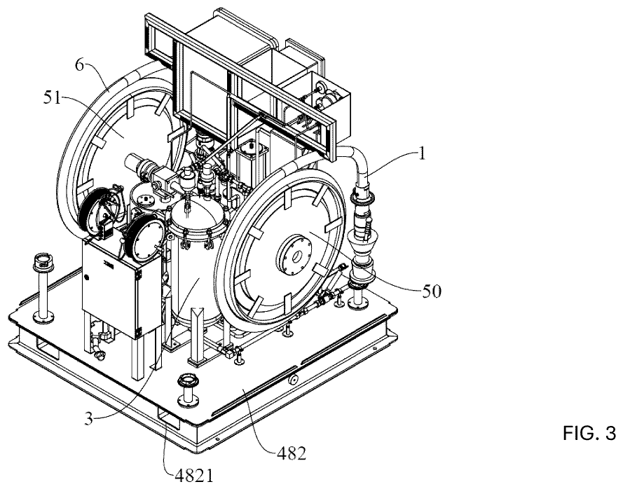

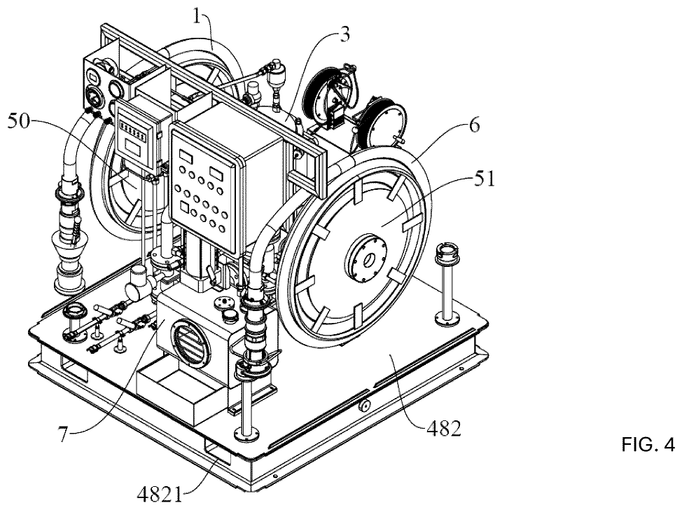

A specific structure of a marine tank transfer refueling system according to specific embodiments of the present disclosure will be described below with reference to FIGS. 1 to 4

The present disclosure discloses a marine tank transfer refueling system. The marine tank transfer refueling system includes a first hose 1, an aviation fuel pump 2, a filter separator 3, a flowmeter 4, an automatic regulating valve 5 and a second hose 6 which are connected in sequence. The first hose 1 is configured to be connected to a fuel supply tank. The second hose 6 is configured to be connected to a fuel receiving tank. The marine tank transfer refueling system further includes a return fuel tank 7. The filter separator 3 has a first communication port 301, a second communication port 302, a third communication port 303, a fourth communication port 304 and a fifth communication port 305. The first communication port 301 communicates with the aviation fuel pump 2. The second communication port 302 communicates with the flowmeter 4. The third communication port 303 is configured to be connected to the fuel unloading pipe 8 and is configured to release residual fuel to an external device. The fourth communication port 304 communicates with a first fuel port 701 of the return fuel tank 7 through an air discharge valve 42. The fifth communication port 305 communicates with a first pipeline 9 between the aviation fuel pump 2 and the first hose 1. A second fuel port 702 of the return fuel tank 7 communicates with the first pipeline 9, and a position where the second fuel port 702 and the first pipeline 9 are connected is located upstream of a position where the fifth communication port 305 and the first pipeline 9 are connected. The return fuel tank 7 further has a fuel unloading port 703 for releasing residual fuel. It is to be understood that in the actual working process, the first hose 1 and the second hose 6 are respectively connected to the fuel supply tank and the fuel receiving tank, and the working state of the aviation fuel pump 2 is controlled according to actual needs, so that the aviation fuel within the fuel supply tank is injected into the fuel receiving tank (such as, the fuel tank of the helicopter), or the aviation fuel in the fuel receiving tank is pumped into the fuel supply tank. Since the flowmeter 4 and the automatic regulating valve 5 are disposed on the fuel circuit, the opening/closing of the automatic regulating valve 5 and the synchronous start/stop of the aviation fuel pump 2 are determined according to the feedback of the signal of the flowmeter 4, to achieve the controllable transferring or refueling of the aviation fuel. By means of this feedback adjustment, the structural limitation of refueling or transferring is reduced. As a result, it can be compatible with various models of fuel tanks for refueling or transferring, thereby being conducive to improving the compatibility of the marine tank transfer refueling system. The additional fuel return tank 7 is used to balance the pressure in the fuel circuit, so that a zero-pressure storage condition inside the entire fuel circuit is ensured, thereby improving the working safety of the marine tank transfer refueling system. In addition, the fuel return tank 7 and the filter separator 3 are respectively provided with the fuel unloading port 703 and the fuel unloading pipe 8, so that the residual fuel can be released to the outside of the device, and the phenomenon of excessively high pressure inside the fuel circuit is further avoided, thereby further improving the working safety of the marine tank transfer refueling system.

Optionally, a manual fuel unloading valve 41 is disposed on the fuel unloading pipe 8, the fuel unloading port 703 is provided with a fuel unloading valve group 40, and the fuel unloading valve group 40 includes a manual valve and an automatic valve connected in series. Therefore, in the actual working process, the fuel unloading of the marine tank transfer refueling system can be achieved according to actual needs, thereby improving the working flexibility of the marine tank transfer refueling system.

Optionally, the aviation fuel pump 2 may be selected as a centrifugal pump suitable for aviation fuel and is driven by a motor. The outlet pressure of the aviation fuel pump 2 is 2 bar and the flow rate of the aviation fuel pump 2 is 300 L/min. A non-spark coupling is used to be connected to the motor, and a drainage tank is added at the front end of the inlet of the aviation fuel pump 2 to make the pump unit have the self-priming function.

Optionally, referring to FIG. 1, the marine tank transfer refueling system further includes a closed-circuit sampler 10. An inlet of the closed-circuit sampler 10 is connected to the filter separator 3 and may be configured to detect fuel flowing into and/or out of the filter separator 3, and an outlet of the closed-circuit sampler 10 is connected to the fuel return tank 7. It is to be understood that the additional closed-circuit sampler 10 may test the aviation fuel flowing into and/or out of the filter separator 3 according to actual needs, thereby achieving real-time testing of the aviation fuel condition and avoiding the aviation fuel with excessive impurities from entering the aircraft.

Further optionally, referring to FIG. 1, the marine tank transfer refueling system further includes a sampling main pipe 11 and multiple sampling branch pipes. One end of the sampling main pipe 11 is connected to the inlet of the closed-circuit sampler 10. The multiple sampling branch pipes are disposed in parallel, one end of each sampling branch pipe is connected to the sampling main pipe 11, and the other end of each sampling branch pipe is connected to the filter separator 3. It is to be understood that one sampling main pipe 11 connected to the inlet of the closed-circuit sampler 10 and the multiple sampling branch pipes each connected to the filter separator 3 are provided so that the testing of the aviation fuel flowing into and/or out of the filter separator 3 can be ensured, and the pipeline structure of the entire marine tank transfer refueling system can be simplified, thereby facilitating assembly of the marine tank transfer refueling system and reducing the manufacturing cost of the marine tank transfer refueling system.

Further optionally, referring to FIG. 1, the sampling branch pipe includes a first sampling pipeline 12. One end of the first sampling pipeline 12 communicates with a second pipeline 18 between the first communication port 301 and the aviation fuel pump 2, the other end of the first sampling pipeline 12 communicates with the sampling main pipe 11, and a first sampling control valve 13 is disposed on the first sampling pipeline 12. It is to be understood that in the actual working process, after the aviation fuel enters the second pipeline 18 under the drive of the aviation fuel pump 2, when the first sampling control valve 13 is opened, the aviation fuel may enter the first sampling pipeline 12, and pass through the sampling main pipe 11 and then enter the closed-circuit sampler 10, thereby achieving the test of aviation fuel flowing to the filter separator 3. In the embodiments of the present disclosure, one first sampling control valve 13 is provided and may be the manual valve or the automatic valve; or two first sampling control valves 13 are provided and are the manual valve and the automatic valve, respectively.

Further optionally, referring to FIG. 1, the sampling branch pipe further includes a second sampling pipeline 14. One end of the second sampling pipeline 14 communicates with the third pipeline 19 between the second communication port 302 and the flowmeter 4, the other end of the second sampling pipeline 14 communicates with the sampling main pipe 11, and a second sampling control valve 15 is disposed on the second sampling pipeline 14. It is to be understood that in the actual working process, the aviation fuel enters the filter separator 3 under the drive of the aviation fuel pump 2, when the second sampling control valve 15 is opened, the aviation fuel can enter the second sampling pipeline 14 after leaving the filter separator 3, and then can enter the closed-circuit sampler 10 after passing through the sampling main pipe 11, thereby achieving the test of aviation fuel flowing out of the filter separator 3. In the embodiments of the present disclosure, one second sampling control valve 15 is provided and may be the manual valve or the automatic valve; or two second sampling control valves 15 are provided and are the manual valve and the automatic valve, respectively.

Further optionally, referring to FIG. 1, the sampling branch pipe further includes a third sampling pipeline 16. One end of the third sampling pipeline 16 is connected to the fuel unloading pipe 8, the other end of the third sampling pipeline 16 communicates with the closed-circuit sampler 10, and a third sampling control valve 17 is disposed on the third sampling pipeline 16. It is to be understood that in the actual working process, the aviation fuel enters the filter separator 3 under the drive of the aviation fuel pump 2, when the third sampling control valve 17 is opened, the aviation fuel enters the fuel unloading pipe 8 after leaving the filter separator 3 and, then enters the third sampling pipe 16, and then enters the closed-circuit sampler 10 after passing through the sampling main pipe 11, thereby achieving the test of aviation fuel flowing out of the filter separator 3. In the embodiments of the present disclosure, one third sampling control valve 17 is provided and may be the manual valve or the automatic valve; or two third sampling control valves 17 are provided and are the manual valve and the automatic valve, respectively.

Further optionally, the marine tank transfer refueling system further includes a test branch pipe 20. One end of the test branch pipe 20 is connected to the second sampling pipeline 14, and the test branch pipe 20 intersects with and is connected to the first sampling pipeline 12. A first differential pressure gauge 21 is disposed on the test branch pipe 20, two sides of the first differential pressure gauge 21 are provided with first connection branch pipes 22, and each first connection branch pipe 22 is provided with a first on-off valve 23. It is to be understood that according to the foregoing, aviation fuel flowing within the first sampling pipeline 12 finally flows towards the filter separator 3, while aviation fuel flowing within the second sampling pipeline 14 finally flows out of the filter separator 3. The additional test branch pipe 20 and the first differential pressure gauge 21 may measure a pressure difference between the aviation fuel flowing into the filter separator 3 and the aviation fuel flowing out of the filter separator 3 to avoid the occurrence of the phenomenon of an excessive pressure difference, and the additionally first connection branch pipe 22 and the first on-off valve 23 may be used for pressure relief when the pressure difference is excessively large, thereby preventing the occurrence of the phenomenon of pipeline damage caused by the excessive pressure difference. In this embodiment, the first on-off valve 23 may be the manual valve or the automatic valve. When the first on-off valve 23 is the automatic valve, the first on-off valve 23 may be a pneumatic valve or an electric valve.

Referring to FIG. 1, a fourth pipeline 24 between the fifth communication port 305 and the first pipeline 9 is sequentially provided with a second on-off valve 25, a safety valve 26, a safety control valve 47, an electromagnetic control valve 27, a first one-way valve 28 and a third on-off valve 29. A second connection branch pipe 30 is connected to the pipeline between the first one-way valve 28 and the second on-off valve 25, and a second differential pressure gauge 31 is disposed on the second connection branch pipe 30. It is to be understood that in the actual working process, when the second on-off valve 25, the electromagnetic control valve 27 and the third on-off valve 29 are opened, the aviation fuel within the filter separator 3 may enter the fourth pipeline 24 through the fifth communication port 305, and then may flow back to the first pipeline 9 sequentially through the second on-off valve 25, the safety valve 26, the safety control valve 47, the electromagnetic control valve 27, the first one-way valve 28 and the third on-off valve 29. This flow path enables aviation fuel filtered by the filter separator 3 to re-enter the delivery circuit, thereby achieving the secondary filtration of the aviation fuel and being conducive to enhancing the cleanliness of the aviation fuel. Moreover, the residual pressure in the entire marine tank transfer refueling system can be released into the oil return tank 7, whereby the zero-pressure storage condition of the pipeline is ensured, and the working safety of the marine tank transfer refueling system is further improved.

Optionally, the marine tank transfer refueling system further includes a fifth pipeline 32. One end of the fifth pipeline 32 is connected to the fourth pipeline 24, and the other end of the fifth pipeline 32 is provided with a third differential pressure gauge 33. The fifth pipeline 32 intersects with the fourth pipeline 24. A middle part of the fifth pipeline 32 is connected to a middle part of the fourth pipeline 24, and a position where the middle part of the fifth pipeline 32 and the middle part of the fourth pipeline 24 are connected is located between the electromagnetic control valve 27 and the first one-way valve 28, and the fifth pipeline 32 is provided with a manual pressure relief valve 34 and a second one-way valve 35 located on two sides of the position where the middle part of the fifth pipeline 32 and the middle part of the fourth pipeline 24 are connected. It is to be understood that in the actual working process, the aviation fuel passing through the fifth communication port 305 may enter the fifth pipeline 32 after passing through the second on-off valve 25, the safety valve 26 and the electromagnetic control valve 27, and then may flow to the third differential pressure gauge 33 after passing through the second one-way valve 35. The third differential pressure gauge 33 is capable of detecting the fuel pressure in the fifth pipeline 32. When the fuel pressure is too large, the pressure relief can be relieved by opening the manual pressure relief valve 34, whereby the zero-pressure storage condition of the pipeline is ensured, and the working safety of the marine tank transfer refueling system is further improved.

Optionally, referring to FIG. 1, the marine tank transfer refueling system further includes a three-way control valve 36. The three-way control valve 36 has a first valve port 361, a second valve port 362 and a third valve port 363. The first valve port 361 is connected to the first hose 1. The second valve port 362 is connected to the aviation fuel pump 2. The third valve port 363 is connected to the second fuel port 702 of the fuel return tank 7, and a third one-way valve 37 is disposed between the third valve port 363 and the second fuel port 702. It is to be understood that the fuel return tank 7 is provided with high liquid level detection. When a high-level alarm occurs in the fuel return tank 7, the three-way control valve 36 in front of the inlet of the aviation fuel pump 2 is switched so that the fuel return tank 7 directly communicates with the aviation fuel pump 2, and the aviation fuel is discharged through the aviation fuel pump 2. After that the fuel level has been completely drained is observed through the sight window, the three-way control valve 36 is switched to a normal fuel supply state. Therefore, the occurrence of the phenomenon of excessive aviation fuel in the fuel return tank 7 is avoided, which is conducive to improving the working safety of the marine tank transfer refueling system.

Optionally, referring to FIG. 1, a fourth on-off valve 43 is disposed between the air discharge valve 42 and the first fuel port 701 of the fuel return tank 7. In this way, in the actual working process, the exhaust valve 42 may communicate with the closed-circuit sampler 10 according to the actual needs, to satisfy the actual test needs.

Optionally, referring to FIG. 1, the marine tank transfer refueling system further includes a parallel branch 44. The parallel branch 44 is disposed in parallel with the automatic regulating valve 5, and a fifth on-off valve 46 and a fourth one-way valve 45 are disposed on the parallel branch 44. It is to be understood that when the automatic regulating valve 5 fails, the automatic regulating valve 5 may be overhauled while ensuring smooth fuel circuit by means of opening the fifth on-off valve 46 and the fourth one-way valve 45, thereby achieving the non-stop overhauling of the marine tank transfer refueling system, which is conducive to improving the overhauling efficiency and the practical satisfaction of users.

Optionally, referring to FIG. 1, the fifth communication port 305 communicates with the first pipeline 9 through the fourth pipeline 24. The marine tank transfer refueling system further includes a coarse filter ball valve assembly 38. The coarse filter ball valve assembly 38 is mounted between the aviation fuel pump 2 and the first hose 1 and is located downstream of a position where the fourth pipeline 24 and the first pipeline 9 communicate with each other. It is to be understood that in the actual working process, after the aviation fuel is pumped out from the fuel supply tank, the aviation fuel firstly passes through the coarse filter ball valve assembly 38, and then flows towards the aviation fuel pump 2. The coarse filter ball valve assembly 38 is configured to filter the aviation fuel, thereby reducing the impurity content in the aviation fuel, and playing a role in protecting the aviation fuel pump 2. It is additionally noted that, in this embodiment, the configuration of the coarse filter ball valve assembly 38 may be selected according to the actual situation, and the specific configuration of the coarse filter ball valve assembly 38 is not limited here.

Optionally, referring to FIG. 1, the marine tank transfer refueling system further includes a self-priming tank 39 mounted upstream of the coarse filter ball valve assembly 38. When no fuel exists in the system pipeline and the fuel level of the fuel supply tank is too low to be transported to the aviation fuel pump 2, the aviation fuel pump 2 is started after the self-priming tank 39 mounted in front of the inlet valve of the aviation fuel pump 2 is filled with fuel, and the aviation fuel in the fuel supply tank is diverted to the aviation fuel pump 2 to ensure that the aviation fuel pump 2 does not idle, thereby ensuring the safety requirements of the system. It is additionally noted that the volume of the self-priming tank 39 may be selected according to actual needs, and in this embodiment, the volume of the self-priming tank 39 is 25 L. Of course, in other embodiments of the present disclosure, the volume of the self-priming tank 39 may be adjusted according to actual needs and is not limited to 25 L. A defoaming device is disposed within the self-priming tank 39, and the defoaming device is configured to remove foam generated in the self-priming process of the self-priming tank 39.

In some embodiments, the marine tank transfer refueling system includes a support seat 48. The support seat 48 includes a support frame 481 and a support bottom plate 482. The support frame 481 is mounted on the support bottom plate 482. The support bottom plate 482 is provided with a forklift handling hole 4821. A rolling shutter door, a protective net, and a mounting lifting lug 49 are disposed on the support frame 481, and the aviation fuel pump 2, the filter separator 3, the flowmeter 4, the automatic regulating valve 5 and the return fuel tank 7 are mounted on the support bottom plate 482. It is to be understood that the support frame 481 has the rolling shutter door on the front side, the detachable protective net on the side, and a detachable protective plate on the top side, which is not only used to protect the components in the device during transportation or hoisting, but also is convenient to disassemble during maintenance and thus facilitate the overhauling. The support bottom plate 482 is configured with the mounting lifting lug 49 and the forklift handling hole 4821, whereby movement for tank replenishment and refueling can be achieved through hoisting and displacement of a tool such as a forklift, thereby making it suitable for multiple emergency working conditions.

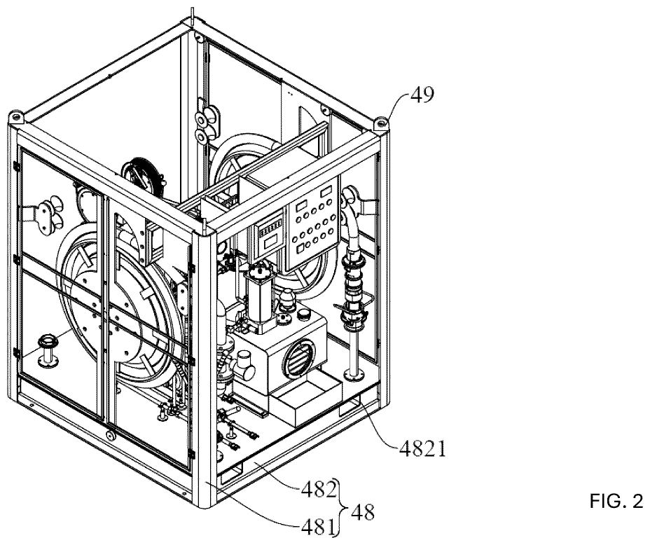

Referring to FIGS. 2 to 4, the marine tank transfer refueling system further includes a first hose reel 50 and a second hose reel 51. The first hose 1 is wound around the first hose reel 50, and the second hose 6 is wound around the second hose reel 51. It is to be understood that the marine tank dumping refueling system is configured with the first hose reel 50 and the second hose reel 51, and the internal joint enables quick-detach connection, thereby allowing the refueling gun or the joint to be drawn out in different application scenarios, which significantly improves the convenience of the fuel transferring device.

Optionally, the first hose reel 50 and the second hose reel 51 are symmetrically arranged inside the support frame 481 in consideration of the position of the center of gravity of the marine tank transfer refueling system.

Optionally, the first hose reel 50 and the second hose reel 51 are made of SS316L and may be rewound manually. The first hose reel 50 and the second hose reel 51 are equipped with a refueling gun with a gun nozzle of 1.5 inches, and are also equipped with a stainless steel filter screen, a dust cap, an electrostatic conductive clip, and a plug.

The advantages of the marine tank transfer refueling system according to the embodiments of the present disclosure are as follows.

Firstly, safety and reliability: all electrical appliances have an explosion-proof design, the support seat 48 is equipped with a fire extinguishing device, an anti-static reel device and a pull-off valve, and the aviation fuel pump 2 has the self-priming function so as to avoid idling and ensure safety.

Secondly, convenient maintenance: the support frame 481 has the rolling shutter door on the front, the detachable protective net on the side, and the detachable protective plate on the top. This design is not only used to protect the components in the device during transportation or hoisting, but also is convenient to disassemble during maintenance, thereby facilitating the overhauling.

Thirdly: light and flexible: a weight of the entire refueling device is less than 2 T, and the refueling device is equipped with the mounting lifting lug 49 and the forklift handling hole 4821, whereby movement for tank replenishment and refueling can be achieved through hoisting and displacement of the tool such as the forklift, thereby making it suitable for multiple emergency working conditions.

Fourthly: simple and efficient: the system allows the aviation kerosene to be injected into the aviation kerosene tank via the aviation fuel pump 2, the filter separator 3, the flowmeter 4 and the like are satisfied. In emergency situations, the aviation kerosene can also be injected into the aircraft fuel tank or other fuel receiving equipment through the gravity refueling gun. Moreover, it has quantitative and timed refueling functions, resulting in relatively high user satisfaction.

It is to be noted that in the description of this specification, terms “some embodiments” and “other embodiments” herein mean that specific features, specific structures, specific materials, or specific characteristics described in connection with an embodiment or example are included in at least one embodiment or example of the present disclosure. In this specification, illustrative expressions of the above terms do not necessarily refer to the same embodiment or example. Moreover, the specific features, the specific structures, the specific materials, or the specific characteristics described may be combined in any one or more embodiments or examples in any suitable manner.

1. A marine tank transfer refueling system, comprising a first hose, an aviation fuel pump, a filter separator, a flowmeter, an automatic regulating valve and a second hose which are connected in sequence, wherein the first hose is configured to be connected to a fuel supply tank, the second hose is configured to be connected to a fuel receiving tank, the marine tank transfer refueling system further comprises a return fuel tank, the filter separator has a first communication port, a second communication port, a third communication port, a fourth communication port and a fifth communication port, the first communication port communicates with the aviation fuel pump, the second communication port communicates with the flowmeter, the third communication port is configured to be connected to a fuel unloading pipe and release residual fuel to an external device, the fourth communication port communicates with a first fuel port of the return fuel tank through an air discharge valve, the fifth communication port communicates with a first pipeline between the aviation fuel pump and the first hose, a second fuel port of the return fuel tank communicates with the first pipeline, a position where the second fuel port and the first pipeline are connected is located upstream of a position where the fifth communication port and the first pipeline are connected, and the return fuel tank further has a fuel unloading port for releasing residual fuel, aviation fuel in the filter separator is capable of flowing back to the first pipeline through the fifth communication port to undergo secondary filtration.

2. The marine tank transfer refueling system of claim 1, further comprising a closed-circuit sampler, wherein an inlet of the closed-circuit sampler is connected to the filter separator and is configured to detect fuel flowing into and/or out of the filter separator, and an outlet of the closed-circuit sampler is connected to the return fuel tank.

3. The marine tank transfer refueling system of claim 2, further comprising:
a sampling main pipe, wherein one end of the sampling main pipe is connected to the inlet of the closed-circuit sampler; and
a plurality of sampling branch pipes, wherein the plurality of sampling branch pipes are disposed in parallel, an end of each sampling branch pipe of the plurality of sampling branch pipes is connected to the sampling main pipe, and another end of each sampling branch pipe of the plurality of sampling branch pipes is connected to the filter separator.

4. The marine tank transfer refueling system of claim 3, wherein each sampling branch pipe of the plurality of sampling branch pipes comprises a first sampling pipeline, a second sampling pipeline and a third sampling pipeline, wherein, one end of the first sampling pipeline communicates with a second pipeline between the first communication port and the aviation fuel pump, another end of the first sampling pipeline communicates with the sampling main pipe, and a first sampling control valve is disposed on the first sampling pipeline;
one end of the second sampling pipeline communicates with a third pipeline between the second communication port and the flowmeter, another end of the second sampling pipeline communicates with the sampling main pipe, and a second sampling control valve is disposed on the second sampling pipeline; and
one end of the third sampling pipeline is connected to the fuel unloading pipe, another end of the third sampling pipeline communicates with the closed-circuit sampler, and a third sampling control valve is disposed on the third sampling pipeline.

5. The marine tank transfer refueling system of claim 4, further comprising a test branch pipe, wherein one end of the test branch pipe is connected to the second sampling pipeline, the test branch pipe intersects with and is connected to the first sampling pipeline, a first differential pressure gauge is disposed on the test branch pipe, two sides of the first differential pressure gauge are provided with first connection branch pipes, and a first on-off valve is disposed on each first connection branch pipe of the first connection branch pipes.

6. The marine tank transfer refueling system of claim 1, wherein a fourth pipeline between the fifth communication port and the first pipeline is sequentially provided with a second on-off valve, a safety valve, an electromagnetic control valve, a first one-way valve and a third on-off valve, a pipeline between the first one-way valve and the second on-off valve is connected to a second connection branch pipe, and a second differential pressure gauge is disposed on the second connection branch pipe; and
the marine tank transfer refueling system further comprises a fifth pipeline, one end of the fifth pipeline is connected to the fourth pipeline, another end of the fifth pipeline is provided with a third differential pressure gauge, the fifth pipeline intersects with the fourth pipeline, a middle part of the fifth pipeline is connected to a middle part of the fourth pipeline, and a position where the middle part of the fifth pipeline and the middle part of the fourth pipeline are connected is located between the electromagnetic control valve and the first one-way valve, and a manual pressure relief valve and a second one-way valve are disposed on the fifth pipeline and are located on two sides of the position where the middle part of the fifth pipeline and the middle part of the fourth pipeline are connected.

7. The marine tank transfer refueling system of claim 1, further comprising a three-way control valve, wherein the three-way control valve has a first valve port, a second valve port and a third valve port, the first valve port is connected to the first hose, the second valve port is connected to the aviation fuel pump, the third valve port is connected to the second fuel port of the return fuel tank, and a third one-way valve is disposed between the third valve port and the second fuel port.

8. The marine tank transfer refueling system of claim 1, wherein the fifth communication port communicates with the first pipeline through a fourth pipeline, the marine tank transfer refueling system further comprises a coarse filter ball valve assembly, the coarse filter ball valve assembly is mounted between the aviation fuel pump and the first hose and is located downstream of a position where the fourth pipeline and the first pipeline are communicated with each other, and the marine tank transfer refueling system further comprises a self-priming tank mounted upstream of the coarse filter ball valve assembly.

9. The marine tank transfer refueling system of claim 1, further comprising a support seat, the support seat comprises a support frame and a support bottom plate, the support frame is mounted on the support bottom plate, the support bottom plate is provided with a forklift handling hole, a rolling shutter door, a protective net, and a mounting lifting lug are disposed on the support frame, and the aviation fuel pump, the filter separator, the flowmeter, the automatic regulating valve and the return fuel tank are mounted on the support bottom plate.

10. The marine tank transfer refueling system of claim 9, further comprising a first hose reel and a second hose reel, wherein the first hose is wound around the first hose reel, and the second hose is wound around the second hose reel.
